(19) United States
(12) Patent Application Publication
(10) Pub. No.: US 2012/0042140 A1
(43) Pub. Date: Feb. 16, 2012

(54) METHOD FOR PROVIDING VIRTUAL OPTICAL DISK FUNCTION IN PORTABLE STORAGE DEVICE AND PORTABLE STORAGE DEVICE WITH VIRTUAL OPTICAL DISK FUNCTION

(76) Inventors: Pi-Hsi Tsai, Hsinchu City (TW); Chih-Wei Wu, Taoyuan County (TW)

(21) Appl. No.: 12/916,635

(22) Filed: Nov. 1, 2010

(30) Foreign Application Priority Data
Aug. 12, 2010 (TW) 099126951

(51) Int. Cl. G06F 12/16; G06F 12/00

(52) U.S. Cl. 711/162; 711/E12.001; 711/E12.103

(57) ABSTRACT

The present invention provides a method for providing a virtual optical disk function in a portable storage device and a portable storage device with a virtual optical disk function. The method for providing the virtual optical disk function in the portable storage device provided by the present invention can make a general standard portable storage device (such as flash drive, memory card, and external hard drive, etc.) to simulate functions of a conventional optical disk device, and have disk ejecting function and disk changing function. In addition, the portable storage device with the virtual optical disk function provided by the present invention can replace the conventional optical disk device to reduce the weight and volume of a computer system (such as notebook computer and desktop personal computer, etc.), and also can replace the virtual optical disk software of the computer system, to avoid occupying memory resource of the computer system.

### BACKGROUND OF THE INVENTION

1. Field of the Invention

The present invention relates to a method for providing a virtual optical disk function and a portable storage device, and more particularly, to a method for providing a virtual optical disk function in a portable storage device and a portable storage device with a virtual optical disk function.

2. Description of the Prior Art

In general, the current computer systems (such as notebook computer and desktop personal computer, etc.) use virtual optical disk softwares to replace the conventional optical disk drives in order to reduce weight and volume. However, the virtual optical disk softwares require memory resource of the computer system, and are not easy to use as the conventional optical disk drives. In addition, the current storage devices used as the virtual optical disk devices are usually utilized for storing some application programs or instruction manuals, and do not have the disk ejecting function and the disk changing function.

### SUMMARY OF THE INVENTION

It is therefore one of the objectives of the present invention to provide a method for providing a virtual optical disk function in a portable storage device and a portable storage device with a virtual optical disk function, so as to solve the above problem.

In accordance with an embodiment of the present invention, a method for providing a virtual optical disk function in a portable storage device is disclosed. The method comprises: dividing a memory unit of the portable storage device to at least a virtual optical disk area and an ordinary data storage area; copying a plurality of files to the virtual optical disk area as a plurality of virtual optical disks, respectively; and performing a virtual optical disk changing operation in the plurality of virtual optical disks of the portable storage device.

In accordance with an embodiment of the present invention, a method for providing a virtual optical disk function in a portable storage device is further disclosed, wherein the portable storage device is externally connected to a computer system, and the method comprises: searching at least a mirror image file in the computer system or in a memory unit of the portable storage device as at least a virtual optical disk; selecting a specific virtual optical disk for the at least a virtual optical disk; and reading content of the specific virtual optical disk and report the content of the specific virtual optical disk to the computer system.

In accordance with an embodiment of the present invention, a portable storage device with a virtual optical disk function is disclosed. The portable storage device comprises: a memory unit and a control unit. The control unit is coupled to the memory unit, and utilized for dividing the memory unit to at least a virtual optical disk area and an ordinary data storage area, and copying a plurality of files to the virtual optical disk area respectively as a plurality of virtual optical disks, and performing a virtual optical disk changing operation in the plurality of virtual optical disks.

In accordance with an embodiment of the present invention, a portable storage device with a virtual optical disk function is further disclosed. The portable storage device comprises: an interface unit, a memory unit, and a control unit. The interface unit is utilized for electrically connecting to a computer system. The control unit is coupled between the interface unit and the memory unit, and utilized for searching at least a mirror image file in the computer system or in a memory unit of the portable storage device as at least a virtual optical disk, and selecting a specific virtual optical disk for the at least a virtual optical disk, and reading content of the specific virtual optical disk and report the content of the specific virtual optical disk to the computer system.

Briefly summarized, the present invention provides a method for providing a virtual optical disk function in a portable storage device and a portable storage device with a virtual optical disk function. The method for providing the virtual optical disk function in the portable storage device provided by the present invention can make a general standard portable storage device (such as flash drive, memory card, and external hard drive, etc.) to simulate functions of a conventional optical disk device, and have the disk ejecting function and the disk changing function. In addition, the portable storage device with the virtual optical disk function provided by the present invention can replace the conventional optical disk device to reduce the weight and volume of a computer system (such as notebook computer and desktop personal computer, etc.), and also can replace the virtual optical disk software of the computer system, to avoid occupying memory resource of the computer system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified block diagram of a portable storage device with a virtual optical disk function in accordance with a first embodiment of the present invention.

FIG. 2 is a flowchart showing a method for providing a virtual optical disk function in a portable storage device in accordance with a first embodiment of the present invention.

FIG. 3 shows a simplified block diagram of a portable storage device with a virtual optical disk function in accordance with a second embodiment of the present invention.

FIG. 4 is a flowchart showing a method for providing a virtual optical disk function in a portable storage device in accordance with a second embodiment of the present invention.

FIG. 5 is a flowchart showing a method for providing a virtual optical disk function in a portable storage device in accordance with a third embodiment of the present invention.

### DETAILED DESCRIPTION

Certain terms are used throughout the following description and the claims to refer to particular system components. As one skilled in the art will appreciate, manufacturers may refer to a component by different names. This document does not intend to distinguish between components that differ in name but not function. In the following discussion and in the claims, the terms “include”, “including”, “comprise”, and “comprising” are used in an open-ended fashion, and thus should be interpreted to mean “including, but not limited to . . . ”. The terms “couple” and “coupled” are intended to mean either an indirect or a direct electrical connection. Thus, if a first device couples to a second device, that connection may be through a direct electrical connection, or through an indirect electrical connection via other devices and connections.

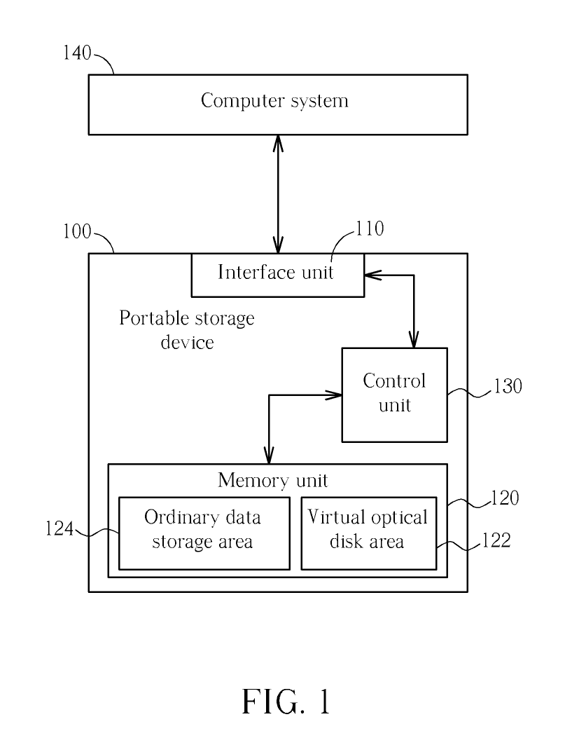

Please refer to FIG. 1. FIG. 1 shows a simplified block diagram of a portable storage device 100 with a virtual optical disk function in accordance with a first embodiment of the present invention. As shown in FIG. 1, the portable storage device 100 comprises: an interface unit 110, a memory unit 120, and a control unit 130. The interface unit 110 is coupled to the control unit 130, and utilized for electrically connecting to a computer system 140. The control unit 130 is coupled between the interface unit 110 and the memory unit 120, and utilized for dividing the memory unit 120 to at least a virtual optical disk area 122 and an ordinary data storage area 124, and copying a plurality of files to the virtual optical disk area 122 respectively as a plurality of virtual optical disks, and performing a virtual optical disk changing operation in the plurality of virtual optical disks.

Please note that the control unit 130 can copy the plurality of files of the ordinary data storage area 124 or the computer system 140 to the virtual optical disk area 122 as the plurality of virtual optical disks, or the control unit 130 can copy the plurality of files of the ordinary data storage area 124 and the computer system to the virtual optical disk area 122 as the plurality of virtual optical disks. The plurality of files can be a plurality of mirror image files. In addition, when there is at least a non-mirror image file exists in the plurality of files, the function of the control unit 130 for copying the plurality of files to the virtual optical disk area 122 can further comprises: converting the non-mirror image file(s) of the plurality of files to mirror image file(s).

In addition, the function of the control unit 130 for performing the virtual optical disk changing operation in the plurality of virtual optical disks of the portable storage device 100 can comprise: utilizing an optical disk inserting command and an optical disk ejecting command to perform the virtual optical disk changing operation in the plurality of virtual optical disks of the portable storage device 100. Or, the function of the control unit 130 for performing the virtual optical disk changing operation in the plurality of virtual optical disks of the portable storage device 100 also can comprise: utilizing a resetting command of the portable storage device 100 to perform the virtual optical disk changing operation in the plurality of virtual optical disks of the portable storage device 100.

For example, presuming that the computer system 140 currently displays that the virtual optical disk in the portable storage device 100 is a virtual optical disk A, when an user wants to make a replacement for the virtual optical disk A, the user can utilize an optical disk ejecting command to eject the virtual optical disk A from the portable storage device 100, and then utilize an optical disk inserting command to insert another virtual optical disk B as a virtual optical disk in the portable storage device 100. Or, the user also can utilize a resetting command to replace the virtual optical disk A with another virtual optical disk B. Please note that the formats of the plurality of virtual optical disks can be various formats such as VCD, DVD, and Blue-ray disk, etc. In addition, please note that the above embodiment is only for an illustrative purpose and is not meant to be a limitation of the present invention.

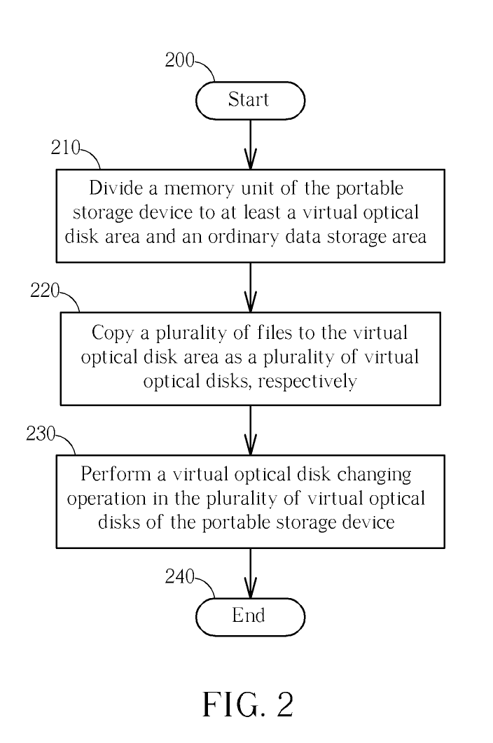

Please refer to FIG. 2. FIG. 2 is a flowchart showing a method for providing a virtual optical disk function in a portable storage device in accordance with the above operation schemes of the portable storage device 100 in a first embodiment of the present invention. Provided that substantially the same result is achieved, the steps of the process flowchart need not be in the exact order shown and need not be contiguous, that is, other steps can be intermediate. The method in accordance with the first embodiment of the present invention comprises the following steps:

Step 200: Start.

Step 210: Divide a memory unit of the portable storage device to at least a virtual optical disk area and an ordinary data storage area.

Step 220: Copy a plurality of files to the virtual optical disk area as a plurality of virtual optical disks, respectively.

Step 230: Perform a virtual optical disk changing operation in the plurality of virtual optical disks of the portable storage device.

Step 240: End.

The Step 220 can comprise: copying the plurality of files of the ordinary data storage area or the computer system to the virtual optical disk area as the plurality of virtual optical disks. Or, the Step 220 also can comprise: copying the plurality of files of the ordinary data storage area and the computer system to the virtual optical disk area as the plurality of virtual optical disks. Please note that the plurality of files can be a plurality of mirror image files. In addition, when there is at least a non-mirror image file exists in the plurality of files, the Step 220 can comprise: converting the non-mirror image file(s) of the plurality of files to mirror image file(s).

In addition, the Step 230 can comprise: utilizing an optical disk inserting command and an optical disk ejecting command to perform the virtual optical disk changing operation in the plurality of virtual optical disks of the portable storage device. Or, the Step 230 also can comprise: utilizing a resetting command of the portable storage device to perform the virtual optical disk changing operation in the plurality of virtual optical disks of the portable storage device.

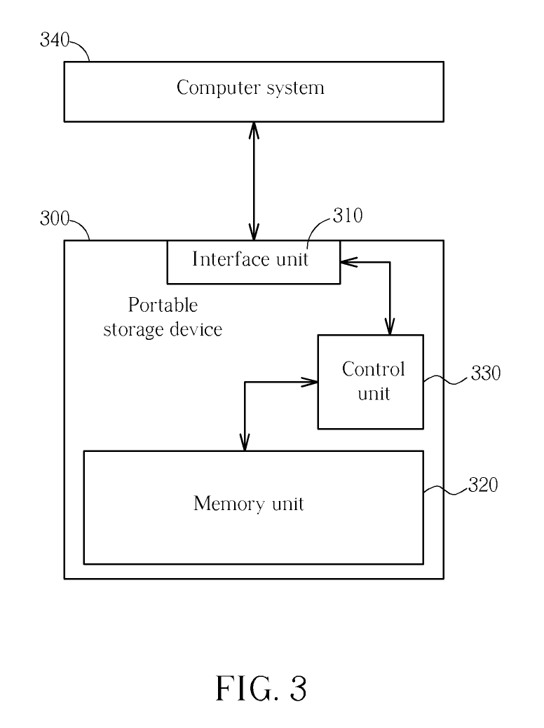

Next, please refer to FIG. 3. FIG. 3 shows a simplified block diagram of a portable storage device 300 with a virtual optical disk function in accordance with a second embodiment of the present invention. As shown in FIG. 3, the portable storage device 300 comprises: an interface unit 310, a memory unit 320, and a control unit 330. The interface unit 310 is coupled to the control unit 330, and utilized for electrically connecting to a computer system 340. The control unit 330 is coupled between the interface unit 310 and the memory unit 320, and utilized for searching at least a mirror image file in the computer system 340 or in a memory unit 320 as at least a virtual optical disk, and selecting a specific virtual optical disk for the at least a virtual optical disk, and reading content of the specific virtual optical disk and report the content of the specific virtual optical disk to the computer system 340.

The function of the control unit 330 for searching the at least a mirror image file in the computer system 340 or in the memory unit 320 as the at least a virtual optical disk comprises: searching a plurality of mirror image files in the computer system 340 or in the memory unit 320 as a plurality of virtual optical disks, and the control unit 330 can further perform a virtual optical disk changing operation in the plurality of virtual optical disks of the portable storage device 300.

In addition, the function of the control unit 330 for performing the virtual optical disk changing operation in the plurality of virtual optical disks of the portable storage device 300 can comprise: utilizing an optical disk inserting command and an optical disk ejecting command to perform the virtual optical disk changing operation in the plurality of virtual optical disks of the portable storage device 300. Or, the function of the control unit 330 for performing the virtual optical disk changing operation in the plurality of virtual optical disks of the portable storage device 300 can comprise: utilizing a resetting command of the portable storage device 300 to perform the virtual optical disk changing operation in the plurality of virtual optical disks of the portable storage device 300. For example, presuming that the computer system 340 currently displays that the virtual optical disk in the portable storage device 300 is a virtual optical disk A, when an user wants to make a replacement for the virtual optical disk A, the user can utilize an optical disk ejecting command to eject the virtual optical disk A from the portable storage device 300, and then utilize an optical disk inserting command to insert another virtual optical disk B as a virtual optical disk in the portable storage device 300. Or, the user also can utilize a resetting command to replace the virtual optical disk A with another virtual optical disk B. Please note that the formats of the plurality of virtual optical disks can be various formats such as VCD, DVD, and Blue-ray disk, etc. In addition, please note that the above embodiment is only for an illustrative purpose and is not meant to be a limitation of the present invention.

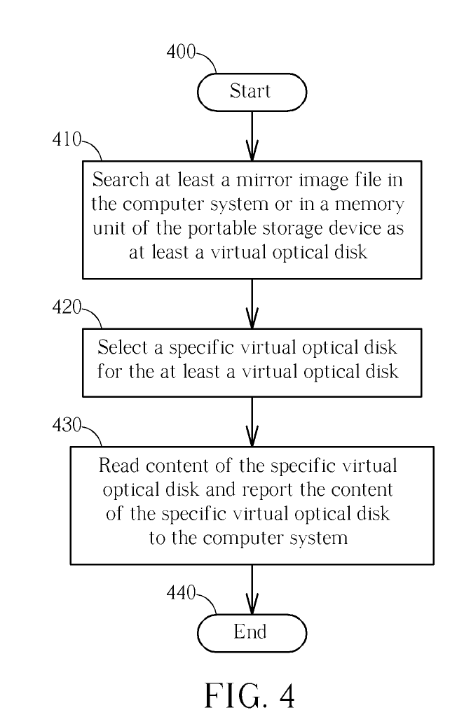

Please refer to FIG. 4. FIG. 4 is a flowchart showing a method for providing a virtual optical disk function in a portable storage device in accordance with the above operation schemes of the portable storage device 300 in a second embodiment of the present invention. Provided that substantially the same result is achieved, the steps of the process flowchart need not be in the exact order shown and need not be contiguous, that is, other steps can be intermediate. The method in accordance with the second embodiment of the present invention comprises the following steps:

Step 400: Start.

Step 410: Search at least a mirror image file in the computer system or in a memory unit of the portable storage device as at least a virtual optical disk.

Step 420: Select a specific virtual optical disk for the at least a virtual optical disk.

Step 430: Read content of the specific virtual optical disk and report the content of the specific virtual optical disk to the computer system.

Step 440: End.

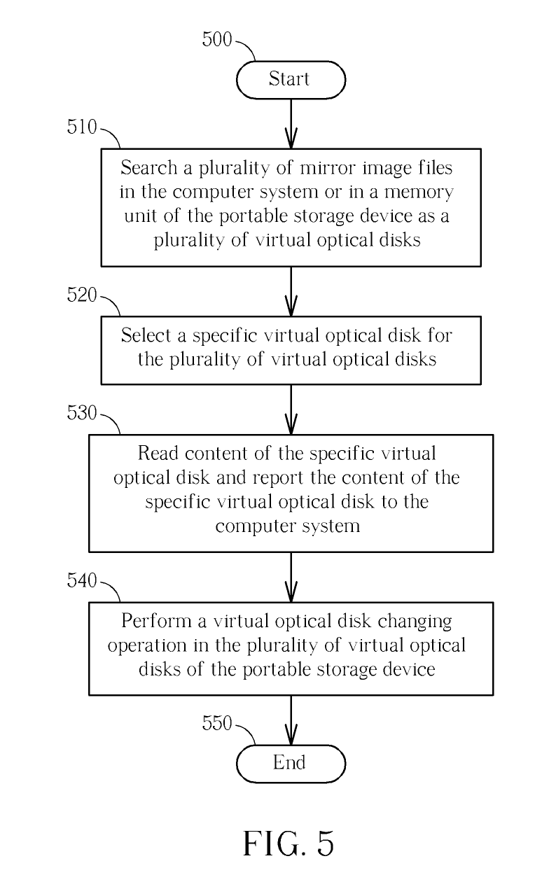

Please refer to FIG. 5. FIG. 5 is a flowchart showing a method for providing a virtual optical disk function in a portable storage device in accordance with the above operation schemes of the portable storage device 300 in a third embodiment of the present invention. Provided that substantially the same result is achieved, the steps of the process flowchart need not be in the exact order shown and need not be contiguous, that is, other steps can be intermediate. The method in accordance with the third embodiment of the present invention comprises the following steps:

Step 500: Start.

Step 510: Search a plurality of mirror image files in the computer system or in a memory unit of the portable storage device as a plurality of virtual optical disks.

Step 520: Select a specific virtual optical disk for the plurality of virtual optical disks.

Step 530: Read content of the specific virtual optical disk and report the content of the specific virtual optical disk to the computer system.

Step 540: Perform a virtual optical disk changing operation in the plurality of virtual optical disks of the portable storage device.

Step 550: End.

Briefly summarized, the present invention provides a method for providing a virtual optical disk function in a portable storage device and a portable storage device with a virtual optical disk function. The method for providing the virtual optical disk function in the portable storage device provided by the present invention can make a general standard portable storage device (such as flash drive, memory card, and external hard drive, etc.) to simulate functions of a conventional optical disk device, and have the disk ejecting function and the disk changing function. In addition, the portable storage device with the virtual optical disk function provided by the present invention can replace the conventional optical disk device to reduce the weight and volume of a computer system (such as notebook computer and desktop personal computer, etc.), and also can replace the virtual optical disk software of the computer system, to avoid occupying memory resource of the computer system.

Those skilled in the art will readily observe that numerous modifications and alterations of the device and method may be made while retaining the teachings of the invention.

What is claimed is:

1. A method for providing a virtual optical disk function in a portable storage device, the method comprising:
dividing a memory unit of the portable storage device to at least a virtual optical disk area and an ordinary data storage area;
copying a plurality of files to the virtual optical disk area as a plurality of virtual optical disks, respectively; and
performing a virtual optical disk changing operation in the plurality of virtual optical disks of the portable storage device.

2. The method of claim 1, wherein the portable storage device is externally connected to a computer system, and the step of copying the plurality of files to the virtual optical disk area as the plurality of virtual optical disks comprises:
copying the plurality of files of the ordinary data storage area or the computer system to the virtual optical disk area as the plurality of virtual optical disks.

3. The method of claim 1, wherein the portable storage device is externally connected to a computer system, and the step of copying the plurality of files to the virtual optical disk area as the plurality of virtual optical disks comprises:
copying the plurality of files of the ordinary data storage area and the computer system to the virtual optical disk area as the plurality of virtual optical disks.

4. The method of claim 1, wherein the step of copying the plurality of files to the virtual optical disk area comprises:
converting non-mirror image file(s) of the plurality of files to mirror image file(s).

5. The method of claim 1, wherein the plurality of files are a plurality of mirror image files.

6. The method of claim 1, wherein the step of performing the virtual optical disk changing operation in the plurality of virtual optical disks of the portable storage device comprises:
utilizing an optical disk inserting command and an optical disk ejecting command to perform the virtual optical disk changing operation in the plurality of virtual optical disks of the portable storage device.

7. The method of claim 1, wherein the step of performing the virtual optical disk changing operation in the plurality of virtual optical disks of the portable storage device comprises:
utilizing a resetting command of the portable storage device to perform the virtual optical disk changing operation in the plurality of virtual optical disks of the portable storage device.

8. A method for providing a virtual optical disk function in a portable storage device, which is externally connected to a computer system, the method comprising:
searching at least a mirror image file in the computer system or in a memory unit of the portable storage device as at least a virtual optical disk;
selecting a specific virtual optical disk for the at least a virtual optical disk; and
reading content of the specific virtual optical disk and report the content of the specific virtual optical disk to the computer system.

9. The method of claim 8, wherein the step of searching the at least a mirror image file in the computer system or in the memory unit of the portable storage device as the at least a virtual optical disk comprises: searching a plurality of mirror image files in the computer system or in the memory unit of the portable storage device as a plurality of virtual optical disks; and the method further comprises:
performing a virtual optical disk changing operation in the plurality of virtual optical disks of the portable storage device.

10. The method of claim 9, wherein the step of performing the virtual optical disk changing operation in the plurality of virtual optical disks of the portable storage device comprises:
utilizing an optical disk inserting command and an optical disk ejecting command to perform the virtual optical disk changing operation in the plurality of virtual optical disks of the portable storage device.

11. The method of claim 9, wherein the step of performing the virtual optical disk changing operation in the plurality of virtual optical disks of the portable storage device comprises:
utilizing a resetting command of the portable storage device to perform the virtual optical disk changing operation in the plurality of virtual optical disks of the portable storage device.

12. A portable storage device with a virtual optical disk function, comprising:
a memory unit; and
a control unit, coupled to the memory unit, for dividing the memory unit to at least a virtual optical disk area and an ordinary data storage area, and copying a plurality of files to the virtual optical disk area respectively as a plurality of virtual optical disks, and performing a virtual optical disk changing operation in the plurality of virtual optical disks.

13. The portable storage device of claim 12, further comprising:
an interface unit, coupled to the control unit, for electrically connecting to a computer system;
wherein the control unit copies the plurality of files of the ordinary data storage area or the computer system to the virtual optical disk area as the plurality of virtual optical disks.

14. The portable storage device of claim 12, further comprising:
an interface unit, coupled to the control unit, for electrically connecting to a computer system;
wherein the control unit copies the plurality of files of the ordinary data storage area and the computer system to the virtual optical disk area as the plurality of virtual optical disks.

15. The portable storage device of claim 12, wherein the function of the control unit for copying the plurality of files to the virtual optical disk area comprises:
converting non-mirror image file(s) of the plurality of files to mirror image file(s).

16. The portable storage device of claim 12, wherein the plurality of files are a plurality of mirror image files.

17. The portable storage device of claim 12, wherein the function of the control unit for performing the virtual optical disk changing operation in the plurality of virtual optical disks of the portable storage device comprises:
utilizing an optical disk inserting command and an optical disk ejecting command to perform the virtual optical disk changing operation in the plurality of virtual optical disks of the portable storage device.

18. The portable storage device of claim 12, wherein the function of the control unit for performing the virtual optical disk changing operation in the plurality of virtual optical disks of the portable storage device comprises:
utilizing a resetting command of the portable storage device to perform the virtual optical disk changing operation in the plurality of virtual optical disks of the portable storage device.

19. A portable storage device with a virtual optical disk function, comprising:
an interface unit, for electrically connecting to a computer system;
a memory unit; and
a control unit, coupled between the interface unit and the memory unit, for searching at least a mirror image file in the computer system or in a memory unit of the portable storage device as at least a virtual optical disk, and selecting a specific virtual optical disk for the at least a virtual optical disk, and reading content of the specific virtual optical disk and report the content of the specific virtual optical disk to the computer system.

20. The portable storage device of claim 19, wherein the function of the control unit for searching the at least a mirror image file in the computer system or in the memory unit of the portable storage device as the at least a virtual optical disk comprises: searching a plurality of mirror image files in the computer system or in the memory unit of the portable storage device as a plurality of virtual optical disks; and the control unit further performs a virtual optical disk changing operation in the plurality of virtual optical disks of the portable storage device.

21. The portable storage device of claim 20, wherein the function of the control unit for performing the virtual optical disk changing operation in the plurality of virtual optical disks of the portable storage device comprises:
utilizing an optical disk inserting command and an optical disk ejecting command to perform the virtual optical disk changing operation in the plurality of virtual optical disks of the portable storage device.

22. The portable storage device of claim 20, wherein the function of the control unit for performing the virtual optical disk changing operation in the plurality of virtual optical disks of the portable storage device comprises:
utilizing a resetting command of the portable storage device to perform the virtual optical disk changing operation in the plurality of virtual optical disks of the portable storage device.
